(19) United States
(12) Patent Application Publication
(10) Pub. No.: US 2025/0047417 A1
(43) Pub. Date: Feb. 6, 2025

(54) EXPLICIT ACKNOWLEDGEMENT FOR UNRELIABLE TRANSPORT PROTOCOLS

(71) Applicant: MELLANOX TECHNOLOGIES, LTD., Yokneam (IL)

(72) Inventor: Ido Zemah, Tel Aviv (IL)

(21) Appl. No.: 18/229,794

(22) Filed: Aug. 3, 2023

(51) Int. Cl. H04L 1/1607

(52) U.S. Cl. CPC H04L 1/1635; H04L 1/1642

(57) ABSTRACT

Systems and methods herein are system for efficient network communication in an unreliable transport protocol (UTP) using a first processor to provide communication to a second processor using the UTP, where the communication is associated with a set of sequential messages sent over multiple timepoints, where at least one part of the communication includes a request for acknowledgement from the second processor of a receipt of the set of sequential messages, and where the first processor is to receive a summary of the set of sequential messages in a dense format as the acknowledgement.

### TECHNICAL FIELD

At least one embodiment pertains to efficient network communication in unreliable transport protocols (UTP) that can be lossy by using explicit acknowledgement from a receiver of a set of sequential messages.

### BACKGROUND

Communication protocols may be provided for certain network communications, such as Ethernet, to enable standards for communication. In an example, Transmission Control Protocol/Internet Protocol (TCP/IP) and User Datagram Protocol (UDP) allow for sending and receipt of messages. TCP and UDP may be provided as soft layers on top of an IP layer, where TCP and UDP may be transport layer protocols over a network layer protocol of the IP layer. As such, UDP and TCP are considered middle layer protocols that exist between an upper layer, from a session layer, all the way to layers associated with an application on one side, and lower layers associated with data links (network drivers) and with physical or communication hardware features on another side. While TCP is a delivery-ensured protocol with flow control abilities, UDP is an unreliable transport protocol (UTP) that can be lossy as it does not ensure delivery and flow control. For example, acknowledgement of transmission in TCP enables advantages in that communication is guaranteed of receipt, unless other extrinsic failures occur. Similarly, InfiniBand (IB), different from Ethernet, provides transport protocols including reliable connection (RC), reliable datagram (RD), unreliable connection (UC), and unreliable datagram (UD). Of these, UD may be used similarly to UDP, whereas UC allows a dedicated connection for communication but without acknowledgement and may both be further examples of the UTP. While the UTP provides no acknowledgement, there may also be a large amount of communication pertaining to acknowledgement and error checking requirements in TCP and reliable communications. Such communication may exceedingly occupy available bandwidth otherwise needed for other traffic in a network.

### BRIEF DESCRIPTION OF DRAWINGS

FIG. 1 illustrates a system that is subject to embodiments for explicit acknowledgement in unreliable transport protocols;

FIG. 2 illustrates aspects of a system for explicit acknowledgement in unreliable transport protocols, according to at least one embodiment;

FIG. 3 illustrates a protocol flow associated with a system for explicit acknowledgement in unreliable transport protocols, according to at least one embodiment;

FIG. 4 illustrates computer and processor aspects of a system for explicit acknowledgement in unreliable transport protocols, according to at least one embodiment;

FIG. 5 illustrates a process flow in a system for explicit acknowledgement in unreliable transport protocols, according to at least one embodiment;

FIG. 6 illustrates yet another process flow in a system for explicit acknowledgement in unreliable transport protocols, according to at least one embodiment; and

FIG. 7 illustrates a further process flow in a system for explicit acknowledgement in unreliable transport protocols, according to at least one embodiment.

### DETAILED DESCRIPTION

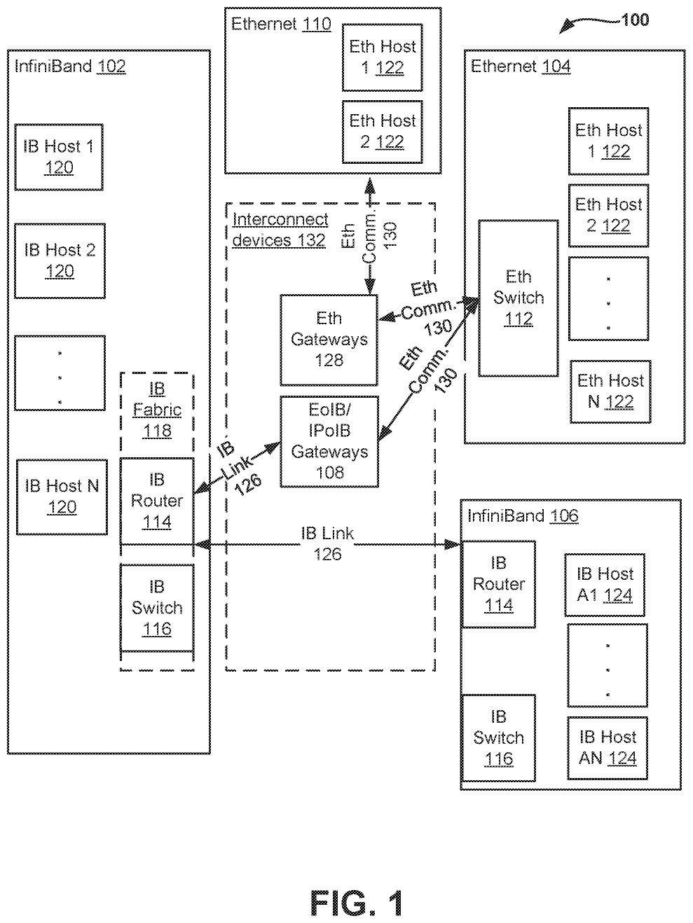

FIG. 1 illustrates a system 100 that is subject to embodiments for explicit acknowledgement in unreliable transport protocols, as detailed herein. The system 100 and a method for such a system 100 enables efficient network communications, in part, by reduction in sender-receiver communication times in an unreliable transport protocol (UTP), such as in UDP or UD. The system 100 and its supported method enable the sender to explicitly request acknowledgement from the receiver of the communication. The system 100 includes a first processor, such as any of processors associated with any of the hosts 120, 122, 124 illustrated to provide communications to a second processor that may be associated with any other ones of the hosts 120, 122, 124 illustrated, where such communications uses the UTP.

The communications may be associated with a set of sequential messages that are sent over multiple timepoints, such as from the first processor to the second processor. At least one communication of such communications may include a request for acknowledgement from the second processor as to the set of sequential messages received. The acknowledgement requested is for a receipt of the set of sequential messages received in the second processor. Further, the acknowledgement from the second processor to the first processor is a summary of the set of sequential messages, in a dense format, as the acknowledgement. The dense format represents lesser bits than the set of sequential messages.

In at least one embodiment, the system 100 and its supported method can address issues of unidirectional communications in UTP that may not support acknowledgement that a receiver computer has received any communication sent over from a sender computer. For example, dropped packets may occur without the sender's knowledge, but with provisions to request acknowledgement and to receive a summary in a dense format, it is possible to provide acknowledgement in an efficient manner because the acknowledgement and the summary may occur after sets of sequential messages are sent, representing a timepoint that is often enough to ensure that available bandwidth is not clogged or occupied.

The system 100 and its supported method can also address issues of lossy aspects of the UTP, where a sender computer sends a request to a receiver computer and assumes or expects a response to the request being received by the receiver computer; but where such a response may need to be limited in view of possible bandwidth congestion. The sender computer might need to limit a number of requests it sends into the network as a result to avoid possible drops of responses due to congestion in the network toward the sender computer. For example, if multiple responses from one or more sender computers are provided in a network, this can cause part of the bandwidth congestion. In addition, as the sender computer waits for responses to arrive after sending a limited number of requests and before sending additional requests into the network, it is apparent that a total communication time will be extend as part of such lossy aspects.

The system 100 and its supported method described herein can address all such issues by enabling a sender computer to request explicit acknowledgement and by supporting an explicit acknowledgement, in response, that occurs after certain events. For example, an event may be post-transmission of a set of sequential messages. The acknowledgement may be also provided as a summary of the received communication, which is a dense format and which occupies less bandwidth than the communications providing the set of sequential messages. This provides a faster acknowledgement transmitted over the available bandwidth.

In at least one embodiment, the dense format is represented by lesser number of bits than the set of sequential messages. For example, the dense format is a bit mask representing the set of sequential messages received by the receiver computer. In this manner, use of a dense format allows identification of a batch of independent requests, as part of the set of sequential messages and to which acknowledgement is to be provided, no matter an order of reception. For example, altering an order or receipt of the messages within the set of sequential messages still results in a summary, after processing the set of sequential messages, that acknowledges at least each message received without harm to the integrity of the operation.

In at least one embodiment, the system 100 and its supported method described herein address responses for each of the requests using a single gathered response at an end of a batch processing that provides the set of sequential messages. A benefit realized from this approach is the efficient network communication in the absence of continuous or individual acknowledgements and the use of explicit acknowledgement requests for UTP. This eliminates individual requests that may be a limitation on the sender's computer because the individual requests limit a number of requests the senders' computer can provide to the network. As such, it is possible to send more requests using the system 100 and its supported method described herein, which can, on the whole, reduce a total communication time by handling the acknowledgement requirements in efficient manner.

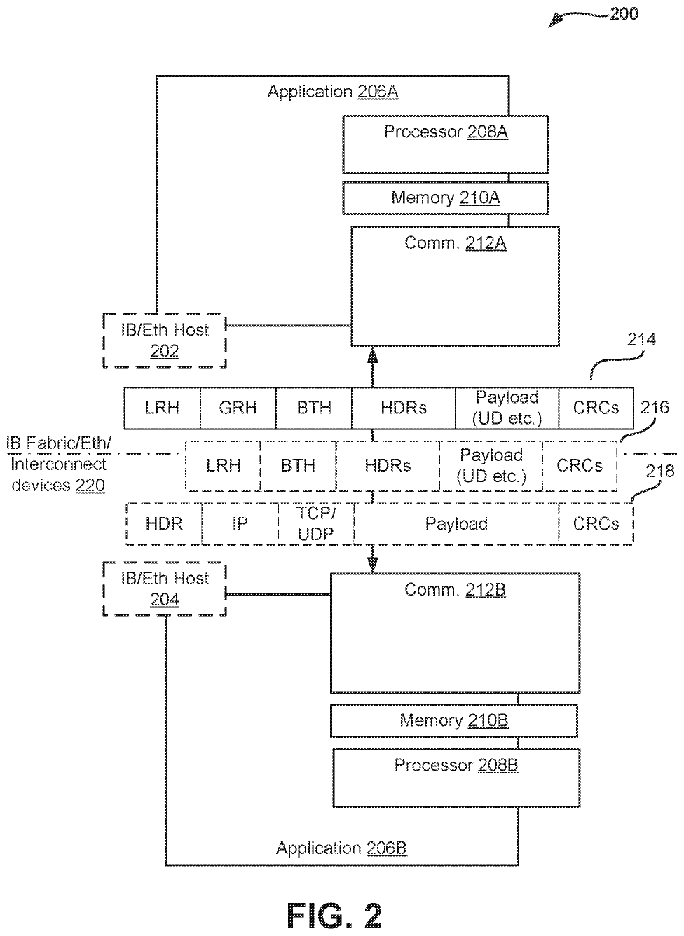

In at least one embodiment, FIG. 1 illustrates a system 100 that is subject to embodiments for explicit acknowledgement in UTPs, as detailed herein. As the explicit acknowledgement applies to any UTP, including UDP of Ethernet type communications between and within local Ethernet networks 104; 110, UD of InfiniBand (IB) type communications between and within local IB networks 102, 106, and UD or UDP provided in Ethernet over IB (EoverIB) communication or even IPoverIB communications. For example, the confluence of two or more of Ethernet, IP, or IB may rely on communication protocols for transport having multiple IB headers (HDRs) over the local route header (LRH), such as a global route header (GRH), base transport header (BTH), etc., as detailed in part in FIG. 2, but may also support UD or UDP, as needed to complete communication requirements between two processors. Further reference to an HDR may be a reference to other headers that are not particularly LRH, GRH, BTH, payload, and cyclic redundancy checks (CRCs), unless otherwise stated. This is also the case for IP packets 218, where reference to HDRs may be other than IP, TCP/UDP, payload, and CRCs, unless otherwise stated.

Therefore, the system 100 in FIG. 1 supports interfacing within one or more IB network 102, 106; within one or more Ethernet networks 104, 110; and between Ethernet networks 104, 110 and IB networks 102, 106. For example, aspects of interconnect devices 132 in an IB network 102; 106 may represent an IB fabric 118 and can at least include multiple IB switches 116 and IB routers 114. Such an IB fabric 118 allows one or more IB hosts 120, 124 to communicate within a subnet or across subnets over one or more designated IB links 126. Even though illustrated via IB routers, an IB link can couple together IB switches within a subnet. An IB link 126 is an abstraction that may include queue pairs (QPs) that bring together a source IB host machine and destination IB host machine for communication with each other. These IB host machines may be within a same subnet or in different subnets. Therefore, each IB network 102, 104 may be a separate subnet, such as a first IB subnet 102 and a second IB subnet 106.

In at least one embodiment, each subnet includes a respective subnet manager (SM). The SM may be a centralized software service that runs on an IB switch 116 or an IB host 120, 124, or other IB device of a subnet. The SM performs functions for discovery of all connected ports and configures all the IB devices (such as IB routers 114 and other IB switches 116) in an IB fabric 118. The SM controls the port arrangements for traffic flow that occurs between the IB hosts 120, 124 via the IB switches 116 within a subnet, for instance. The discovery and configurations of port arrangements are therefore enabled by the SM to support traffic flow between those active ports of relevant IB hosts 120, 124 via the one or more IB switches 116. The SM also applies configurations relating to network traffic, including for Quality of Service (QOS), routing, and partitioning of the IB devices in an IB fabric 118.

While in abstraction, an IB link 126 may be bound to a physical IB port of an IB host 120, 124. Further, an EoverIB or an IPoverIB gateway 108 is capable of supporting IB-to-Ethernet and IP-to-IB communication as part of a group of interconnect devices 132. Separately, IB to IB communications are enabled using IB links 126 between IB routers 114. In addition, Ethernet to Ethernet communications are enabled using Ethernet communication links 130 and using Ethernet gateways 128, as needed, and using Ethernet switches 112 between the Ethernet gateways 128 or the EoverIB/IPoverIB gateways 108.

All of such hosts or host machines may be computer platforms executing respective Operating Systems (OS) to control one or more Ethernet network adapters having one or more Ethernet interfaces and/or ports to communicate via Ethernet or to interface with channel adapters having one or more IB interfaces and/or ports to communicate via IB networks. A host is used interchangeably with a host machine or a computer to describe an IB or Ethernet hosts unless stated expressly otherwise using preceding text IB or Ethernet, where an IB host is exclusively within an IB network and an Ethernet host is exclusively within an Ethernet network. Further, such exclusivity does not restrict IB to Ethernet communications as described throughout herein.

FIG. 2 illustrates aspects of a system 200 for explicit acknowledgement in unreliable transport protocols, according to at least one embodiment. An IB or Ethernet host 202 is associated with a first processor to communicate with at least one second processor associated with a second IB or Ethernet host 204. The communications may include a UTP communication. Further, the IB or Ethernet hosts 202, 204 may be any one of the IB hosts 120, 124 or Ethernet host 122 in FIG. 1. The IB fabric/Ethernet/Interconnect devices 220 may be any of the devices of the IB fabric 118, an Ethernet switch 112, or any of the Interconnect devices 132 of FIG. 1.

For at least the hosts 202, 204 that are IB or Ethernet-enabled, a host processor or other processor may handle almost all aspects of the communication. Although illustrated as a singular unit, each processor 208A, 208B in FIG. 2 may be a central processing unit (CPU), a graphics processing unit (GPU), or a data processing unit (DPU). Further, each illustrated processor 208A; 208B in FIG. 2 may represent one or more processing units that can perform explicit acknowledgement in UTPs. For example, in Ethernet communications, a host CPU may be involved in the explicit acknowledgement in UTPs. In IB communication, a GPU or DPU may circumvent a host CPU to perform aspects of the explicit acknowledgement in UTPs. In at least one embodiment, FIG. 2 illustrates the processor 208A; 208B, a memory 210A; 210B, and communication hardware 212A; 212B, as partly outside a respective application 206A; 206B to support a description of external devices, including switches, routers, and gateways (as illustrated in FIG. 1), which can provide its processors to perform aspects of the explicit acknowledgement in UTPs on behalf of its associated IB or Ethernet host 202; 204.

Such aspects may include preparing packets, data buffering on a sender computer and a receiver computer; data integrity checks such as cyclic redundancy checks (CRCs) or checksum; routing requirements that may be based in part on IP addresses; and signaling between IB, TCP/IP, or Open Systems Interconnection (OSI) layers, such as signals between different layers for processing according to the protocol requirements of each of the levels and interrupts related to receipt or transmission of packets. Therefore, aspects in the explicit acknowledgement in UTPs may be performed between at least one sender processor and at least one receiver processor where such processors may be within a host 120, 122, 124, in a device of the IB fabric 118, in one of the interconnect devices 132, or in an Ethernet device 112.

In an example that is applicable to the hosts 202, 204 that may be Ethernet hosts, an application 206A associated with a sender processor 208A provides a request that may be associated with information requested from or to be communicated with a receiver processor 208B. The receiver processor 208B is associated with a similar or dissimilar application 206B. The request may be a communication that is provided to a memory 210A of an application layer and/or of subsequent TCP/IP or OSI layers, before it is provided for an Ethernet communication. The memory 210A, 210B on the sender and the receiver hosts 202, 204 may be one or more buffers that are associated with respective host processors performing an OS and with one or more other processors of the communication hardware 212A, 212B to enable building or deconstructing packets for the communication.

For Ethernet communications, the communication hardware 212A may be an Ethernet controller or other Ethernet device that is associated with a host processor of the sender host 202. For example, the communication is provided in packages of UDP or TCP messages based in part on requirements from the application 206A of the sender host 202. At least the UDP part of the communication represents a UTP that becomes part of a set of sequential messages that is provided in different IP packets 218 with an indication in at least the TCP/UDP header about the type of the communication. The different IP packets 218 may include source and destination IP addresses that may be converted to physical addresses for transmission at a network layer. A similar communication sequence may occur in reverse on the receiver computer 204 to provide the communication to the application 206B of receiver computer 204. For example, for receiving communications, the communication hardware 212B associated with the receiver computer 204 reverses the sequence to interpret the received messages for the application 206B. Further, as UDP is a UTP, the source and CRC information of the IP packets 218 are optional.

For at least hosts 202, 204 that are IB hosts, processors other than a host processor can communicate and handle almost all aspects of the IB communication. For example, a channel adapter is part of the communication hardware 212A, 212B and has its own processor to perform buffering, packeting, and data integrity checks such as cyclic redundancy checks (CRCs) or checksum. The channel adapter can also perform routing requirements based in part on destination IDs (DIDs) that are local IDs (LIDs), Global Unique Identifiers (GUIDs), or Global IDs (GIDs), from a routing table provided from an SM of the respective subnet to which the hosts 202, 204 belong. Further, signaling between network layers in the IB may be performed by collaboration between the IB fabric and the channel adapter of the respective hosts 202, 204.

In an example that is applicable to hosts 202, 204 that may be IB hosts, an application 206A that is associated with a sender processor 208A provides a request that may be associated with information requested from or to be communicated with a receiver processor 208B. The application 206A that is associated with the sender processor 208A may be a similar or dissimilar application than the application 206B that is associated with the receiver processor 208B. The request may be a communication that is provided to a memory 210A associated with an application layer and that is subsequently provided for an IB communication using Remote Direct Memory Access (RDMA) of the channel adapters, to reach a memory 210B that is associated with a receiver computer 204. Differently than Ethernet, the memory 210A, 210B for IB hosts may be one or more buffers associated with the channel adapter and that can circumvent buffers of a host processor performing an OS of the hosts 202, 204, while building or deconstructing a packet associated with the communication.

In IB, communication is provided from a communication hardware 212A that can perform communication without intervention by a host processor of the sender host 202. For example, the communication is provided in packages of at least UD or RD messages for communication. At least the UD part of the communication represent a UTP that becomes part of set of sequential messages that are provided in different packets 214, 216 as part of a payload. A similar sequence may be reversed and performed on the receiver computer 204 for an application 206B of the receiver computer 204. Further, for receiving communications, the receiver computer 204 and its associated processors at the communication hardware 212B reverses such a flow to provide received messages for the application 206B. In both UDP and UD, handshakes may not be part of an initiation for such communication.

In an example that is applicable to both hosts 202, 204 that are IB and/or Ethernet-enabled, an application 206A that is associated with a sender processor 208A that is Ethernet-enabled provides a request that may be associated with information requested from or to be communicated with a receiver computer 204 that is IB-enabled. The application 206A, 206B on both sides may be a similar or dissimilar applications. The request may be a communication that is provided to a memory 210A that is associated with an application layer as in the IB and Ethernet approaches for the sender host 202 but may be also associated with a data layer in which changes may be made to an IP packet to enable working with an IB network. The memory 210A, 210B is therefore one or more buffers that may be associated with a respective one of the channel adapter or the Ethernet controller to support building of relevant packets for the communication.

Transmission of IB over IP or Ethernet that is applicable to both IB and Ethernet hosts 202, 204 include the use of a network protocol that allows RDMA over TCP/IP or Ethernet. For example, RDMA over TCP/IP may be supported by Ethernet switches that communicate with Ethernet controllers of the both IB and Ethernet hosts 202, 204, such as in software or hardware-enabled network interface cards (NICs) with a CPU offload, whereas RDMA over Ethernet may provide Ethernet headers in the lower network header and may provide the IB header in the higher network headers, along with the payload. Either of these approaches provide RDMA of IB over Ethernet and can support UD or UDP in the payload, but with the explicit acknowledgement aspects described throughout herein.

In at least one embodiment, the system 200 for explicit acknowledgement in UTP includes a first processor that is associated with either an IB or Ethernet host 202 to provide UTP communication packets 214; 216; 218 to a second processor that is a different IB or Ethernet host 204. The different communications are illustrated to indicate compliance with IB, Ethernet, IP, EoverIB (or IBoverE), IPoverIB, or any communication standards that also support a UTP. In at least one embodiment, one or more of these communications standards support RDMA directly, whereas the association of Ethernet and IB provides RDMA in different approaches, including using RDMA over Converged Ethernet (ROCE) for the IBoverE approach; but all such communication standards can implement aspects of the system and method for explicit acknowledgement in any UTP part of the communication standards.

In at least one embodiment, for IPoverIB communications, a first processor that is associated with an Ethernet host 202 to provide UTP communications as packets 218 to a second processor that is associated with an IB host 204 enables registration of an Ethernet interface that is mapped to an IPoverIB interface. Then IP packets 218 that are Ethernet packets are transmitted through such an IPoverIB interface with their Ethernet headers removed and with IP headers passed on, along with the payload, and with IB headers included. This process can be reversed for receipt of Ethernet packets 218 over IB. The removal and replacement of headers may be performed by an SM or an agent within one of the IB fabric/Ethernet/Interconnect devices 220.

In at least one embodiment, in FIG. 2, IB packets 214, 216 of a communication that includes UTP aspects may have headers for LRH, GRH, BTH, payload, and redundancy checks (CRC), where the payload may be a UTP payload, such as a management datagram (MAD). The IB packets 214, 216 may be used for the IB links 126, in communication between the IB devices in FIG. 1, for instance. The MAD may be of 256 bytes and may be provided in the payload part of an IB packet that is either a subnet management packet (SMP) or a global services management packet (GMP).

In at least one embodiment, the IB packets 214, 216 may be of different types but may be used for UTP communication with explicit acknowledgement. For example, of the IB packets 214, 216 illustrated, a first IB packet 216 may be an SMP that may not include a GRH and only includes an LRH, along with its other headers, as illustrated. Further, an SMP may not be addressed to a port outside of an SM's subnet, such as operating within a first IB subnet 102 or a second IB subnet 106. As such, the UTP payload of an SMP is to manage devices within a subnet. Separately, a second IB packet 214, being a GMP, includes a GRH and can be used to address a port outside of a subnet of its sending IB device. In at least one embodiment, a GMP may include UTP payloads to manage devices in multiple subnets 102, 106.

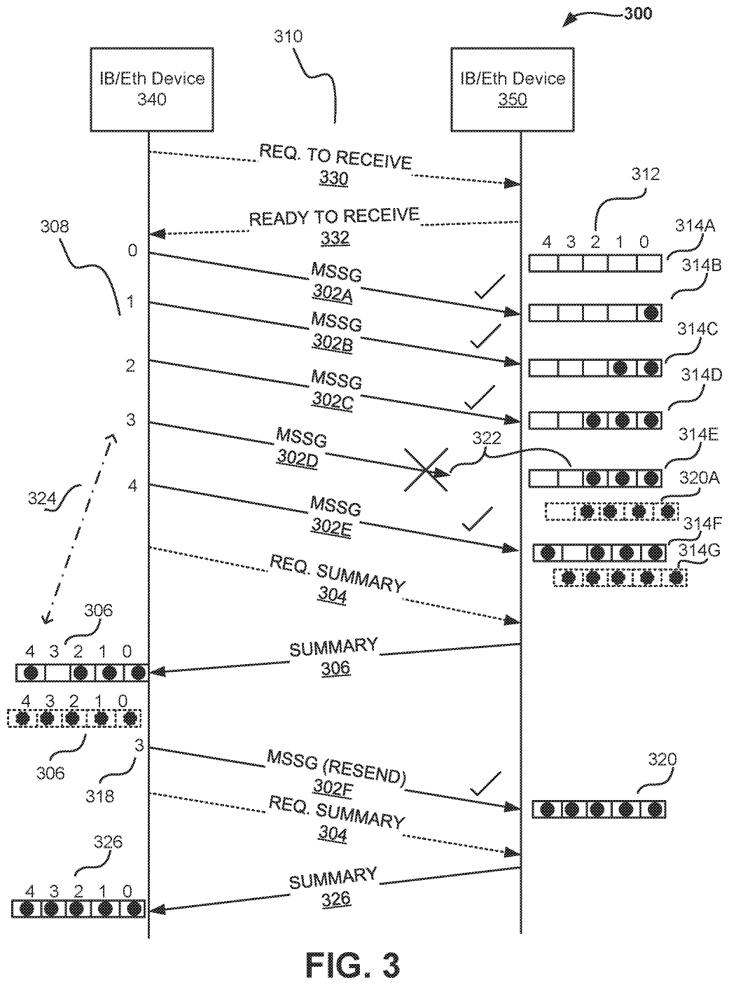

FIG. 3 illustrates a protocol flow 300 that is associated with a system 100; 200 for explicit acknowledgement in unreliable transport protocols, according to at least one embodiment. The explicit acknowledgement in UTP is illustrated with respect to two Ethernet or IB devices 340, 350, which a skilled artisan reading the present disclosure would recognize as being either intermediate devices, such as any of the IB fabric/Ethernet/Interconnect devices 220, or being IB or Ethernet hosts 202, 204 that are associated with the communication hardware 212 that are either IB fabric/Ethernet/Interconnect devices 220 (or that interface with such IB fabric/Ethernet/Interconnect devices 220). Therefore, unless indicated otherwise, the first Ethernet or IB device 340 is generally referred to as the first processor and the second Ethernet or IB device 350 is generally referred to as the second processor,

In at least one embodiment, the payload of the communication, in the illustrated packets 310 (also packets 214-218 in FIG. 2), may be associated with a set of sequential messages 302A-E sent over multiple timepoints. For example, the payload is from a first Ethernet or IB device 340. At least one of the communication 310 includes a request for a summary 304 from a first processor 340 associated with the first Ethernet or IB device to a second processor 350 of a second Ethernet or IB device. The request for a summary 304 is a request of a receipt of the set of sequential messages 302A-E. The second processor 350 can respond with a summary 306 of the set of sequential messages 302A-E in a dense format 314G, as the acknowledgement of what was received. The first processor 340 can receive the summary 306 of the set of sequential messages 302A-E in the dense format 314G as the acknowledgement.

In at least one embodiment, the first processor 340 provides an indication of a size of the set of sequential messages to be provided in a UTP to follow from the first processor 340. The second processor 350 then prepares to hold a bit mask or other dense format representation of the set of sequential messages based in part on the indication of the size of the set of sequential messages. The dense format is represented, in at least one embodiment, by fewer number of bits than the set of sequential messages. For example, the bit mask 312 is prepared for the size of the set of sequential messages (5 bits) and is applied to the packets received 302A-C, E or not received 302D as against all the bits provided for the data 308 (0, 1, 2, 3, 4) in the communications 310 via the messages or packets 302A-E.

As illustrated in FIG. 3, the dense format includes the bit mask 312 that represents the set of sequential messages received by the second processor as each sequential message is received, thereby providing updates from initial bit mask 314A through intermediate bit masks 314B-E, and final bit mask 314F. As also illustrated in FIG. 3, the final bit mask 314F indicates if a dropped packet has occurred in one of an intermediate bit mask 314E, such as that a packet 302D was dropped 322 for any reason during the communication 310. However, if the packet was properly received, a bit mask 320A would reflect this.

In at least one embodiment, the first processor 340 can request for a summary 304 as to the received set of sequential messages from the second processor 350. The second processor 350 provides a summary 306 using the final bit mask 314F. For example, the second processor 350 provides the final bit mask 314F as the summary 306. On its side, the first processor 340 can perform a comparison 324 of the summary 306 of the set of sequential messages 306, as received, to a bit mask generated internally or to the set of sequential messages 308, as sent.

In at least one embodiment, indication that the summary 306 includes a dropped packet relative to the set of sequential messages 308 sent enables the first processor 340 to perform a resend 302F for the dropped packet. For example, the resend 302F is for the data 318 of the dropped packet that is represented as missing in the bit mask 312. The resent packet 302F, once received, may be used to generate a further final bit mask 320 (or to update the final bit mask 314F) in the receiver computer or host 350. A further request for a summary 304 may be provided with a further summary 326 to be provided back from the second processor 350. In addition, the resending of the message 302F, the further request for a summary 304, and the further summary 326 are performed upon a determination of a dropped packet 322 in the prior summary 306 by the comparison 324 performed in the sender computer or host 340.

In at least one embodiment, the dense format may include a list of received sequence numbers or other representation associated with the set of sequential messages, instead of the bit mask 312, which a skilled artisan would understand from the illustrations in FIG. 3 and the description herein. In at least one embodiment, to the extent that the bit mask 312 is complete 314G without dropped packets, then a good communication has occurred and the second processor 350 provides the summary 306 indicative of the complete bit mask. The good communication is recognized in the sender computer or host 340 by the comparison 324 performed so that none of the further resending 302F, the further request for a summary 304, and the further summary 326 may be provided.

In at least one embodiment, the protocol flow 300 that is associated with a system 100; 200 for explicit acknowledgement in UTPs may be initiated by a request to receive 330 message from the first processor 340 to the second processor 350. The request to receive 330 message: may include certain parameters, such as a time limit or a number of sequential messages associated with a set of sequential messages 302A-E to be received by the second processor 350. In at least one embodiment, however, the request to receive 330 message may only include an indication that a forthcoming set of sequential messages 302A-E is under an explicit acknowledgement in a UTP protocol that is previously defined within the communication capabilities of the second processor 350. The communication capabilities may include a time limit or a number of sequential messages that will always be associated with the set of sequential messages 302A-E to be received by the second processor 350.

In at least one embodiment, there may be a ready to receive 332 indication returned to the first processor 340 from the second processor 350. Further, when the protocol flow 300 supports that a request to receive 330 indication is to be sent from the first processor 340 to the second processor 350, which makes the second processor 350 ready to receive a set of sequential messages 302A-E, the request to receive 330 should be acknowledged by a ready to receive 332 indication by the second processor 350 before the first processor 340 can start sending the set of sequential messages 302A-E, if reliability for that request is desired. This is to prevent issues where the request to receive 330 packet may be dropped on its way to the second processor 350, where the second processor 350 may not be ready for the set of sequential messages 302A-E, as a result. The timing requirements in which to transmit the set of sequential messages 302A-E or a count associated with the set of sequential messages 302A-E may start from the ready to receive 332 indication transmitted by the second processor 350.

Once the set of sequential messages 302A-E are sent under such request to receive 330 approach, there may be no request for summary 304 from the first processor 340 to the second processor 350. Instead, following completion of the timing or the count understood by or communicated to the second processor 350, the second processor 350 sends a summary 306 of the set of sequential messages 302A-E in a dense format 314G, as the acknowledgement of what was received. The first processor 340 can receive the summary 306 of the set of sequential messages 302A-E in the dense format 314G as the acknowledgement and can perform the comparison 324. In at least one embodiment, one message of the set of sequential messages 302A-E may be resent 302F or the entire set of sequential messages 302A-E may be resent by the first processor 340 upon determination of a failure in the comparison 324.

Further, the request to receive 330 process may be repeated if the first processor 340 is to resend the set of sequential messages 302A-E. However, in at least one embodiment, the first processor 340 may resent the set of sequential messages 302A-E after receiving the summary and the second processor 350 may already be prepared to accept it without a need for a request to receive 330 indication. In at least one embodiment, the comparison 324 may indicate that some of the set of sequential messages 302A-E may not be received by the second processor 350. Further, there may be a second request for a summary 304 and the second processor 350 may respond with a further summary 326; however, continuing with the request to receive 330 approach, there need not be second request for a summary 304 and, instead, the further summary 326 is resent after one or more of the set of sequential messages 302A-E are received.

In at least one embodiment, one or more of the request to receive 330, the ready to receive 332, the request for summary 304, or the summary 326 may be communicated in a protocol that is other than the UTP. For example, one or more of the request to receive 330, the ready to receive 332, the request for summary 304, or the summary 326 may be communicated using a reliable transport protocol. However, the set of sequential messages 302A-E is always communicated in the UTP. In at least one embodiment, the summary 326 may include a count of a number of received messages of the set of sequential messages 302A-E or may include a count of a number of dropped messages of the set of sequential messages 302A-E. For example, the second processor 350 can determine, from the bit mask, a received count or a dropped count and can communicate only this information as the dense format. The first processor 340 can respond with resending all or one or more of the set of sequential messages 302A-E.

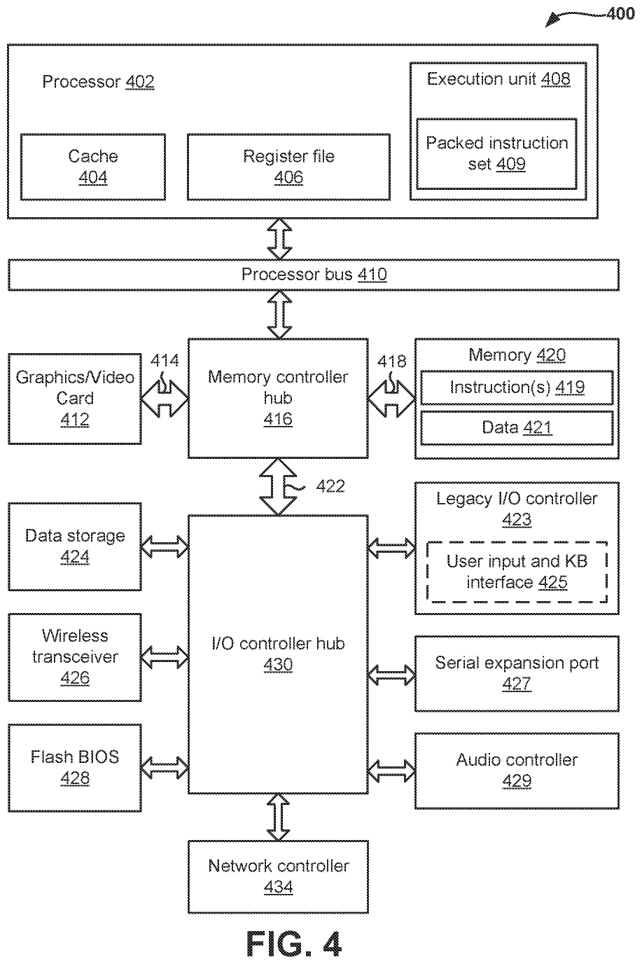

FIG. 4 illustrates computer and processor aspects 400 of a system for explicit acknowledgement in unreliable transport protocols, according to at least one embodiment. The computer and processor aspects 400 may be performed by one or more processors that include a system-on-a-chip (SOC) or some combination thereof formed with a processor that may include execution units to execute an instruction, according to at least one embodiment. Such one or more processors may include CPUs, DPUs, and GPUs. Further, the computer and processor aspects may be within one or more of the IB or Ethernet hosts 202, 204, or the IB fabric/Ethernet/Interconnect devices 220.

In at least one embodiment, the computer and processor aspects 400 may include, without limitation, a component, such as a processor 402 to employ execution units including logic to perform algorithms for process data, in accordance with present disclosure, such as in embodiment described herein. In at least one embodiment, the computer and processor aspects 400 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, the computer and processor aspects 400 may execute a version of WINDOWS operating system available from Microsoft Corporation of Redmond, Wash., although other operating systems (UNIX and Linux, for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“NetPCs”), set-top boxes, network hubs, wide area network (“WAN”) switches, or any other system that may perform one or more instructions in accordance with at least one embodiment.

In at least one embodiment, the computer and processor aspects 400 may include, without limitation, a processor 402 that may include, without limitation, one or more execution units 408 to perform aspects according to techniques described with respect to at least one or more of FIGS. 1-3 and 5-7 herein. In at least one embodiment, the computer and processor aspects 400 is a single processor desktop or server system, but in another embodiment, the computer and processor aspects 400 may be a multiprocessor system.

In at least one embodiment, the processor 402 may include, without limitation, a complex instruction set computer (“CISC”) microprocessor, a reduced instruction set computing (“RISC”) microprocessor, a very long instruction word (“VLIW”) microprocessor, a processor implementing a combination of instruction sets, or any other processor device, such as a digital signal processor, for example. In at least one embodiment, a processor 402 may be coupled to a processor bus 410 that may transmit data signals between processor 402 and other components in computer and processor aspects 400.

In at least one embodiment, a processor 402 may include, without limitation, a Level 1 (“L1”) internal cache memory (“cache”) 404. In at least one embodiment, a processor 402 may have a single internal cache or multiple levels of internal cache. In at least one embodiment, cache memory may reside external to a processor 402. Other embodiments may also include a combination of both internal and external caches depending on particular implementation and needs. In at least one embodiment, a register file 406 may store different types of data in various registers including, without limitation, integer registers, floating point registers, status registers, and an instruction pointer register.

In at least one embodiment, an execution unit 408, including, without limitation, logic to perform integer and floating point operations, also resides in a processor 402. In at least one embodiment, a processor 402 may also include a microcode (“ucode”) read only memory (“ROM”) that stores microcode for certain macro instructions. In at least one embodiment, an execution unit 408 may include logic to handle a packed instruction set 409.

In at least one embodiment, by including a packed instruction set 409 in an instruction set of a general-purpose processor, along with associated circuitry to execute instructions, operations used by many multimedia applications may be performed using packed data in a processor 402. In at least one embodiment, many multimedia applications may be accelerated and executed more efficiently by using a full width of a processor's data bus for performing operations on packed data, which may eliminate a need to transfer smaller units of data across that processor's data bus to perform one or more operations one data element at a time.

In at least one embodiment, an execution unit 408 may also be used in microcontrollers, embedded processors, graphics devices, DSPs, and other types of logic circuits. In at least one embodiment, the computer and processor aspects 400 may include, without limitation, a memory 420. In at least one embodiment, a memory 420 may be a Dynamic Random Access Memory (“DRAM”) device, a Static Random Access Memory (“SRAM”) device, a flash memory device, or another memory device. In at least one embodiment, a memory 420 may store instruction(s) 419 and/or data 421 represented by data signals that may be executed by a processor 402.

In at least one embodiment, a system logic chip may be coupled to a processor bus 410 and a memory 420. In at least one embodiment, a system logic chip may include, without limitation, a memory controller hub (“MCH”) 416, and processor 402 may communicate with MCH 416 via processor bus 410. In at least one embodiment, an MCH 416 may provide a high bandwidth memory path 418 to a memory 420 for instruction and data storage and for storage of graphics commands, data and textures. In at least one embodiment, an MCH 416 may direct data signals between a processor 402, a memory 420, and other components in the computer and processor aspects 400 and to bridge data signals between a processor bus 410, a memory 420, and a system I/O interface 422. In at least one embodiment, a system logic chip may provide a graphics port for coupling to a graphics controller. In at least one embodiment, an MCH 416 may be coupled to a memory 420 through a high bandwidth memory path 418 and a graphics/video card 412 may be coupled to an MCH 416 through an Accelerated Graphics Port (“AGP”) interconnect 414.

In at least one embodiment, the computer and processor aspects 400 may use a system I/O interface 422 as a proprietary hub interface bus to couple an MCH 416 to an I/O controller hub (“ICH”) 430. In at least one embodiment, an ICH 430 may provide direct connections to some I/O devices via a local I/O bus. In at least one embodiment, a local I/O bus may include, without limitation, a high-speed I/O bus for connecting peripherals to a memory 420, a chipset, and processor 402. Examples may include, without limitation, an audio controller 429, a firmware hub (“flash BIOS”) 428, a wireless transceiver 426, a data storage 424, a legacy I/O controller 423 containing user input and keyboard interfaces 425, a serial expansion port 427, such as a Universal Serial Bus (“USB”) port, and a network controller 434. In at least one embodiment, data storage 424 may comprise a hard disk drive, a floppy disk drive, a CD-ROM device, a flash memory device, or other mass storage device.

In at least one embodiment, FIG. 4 illustrates computer and processor aspects 400, which includes interconnected hardware devices or “chips”, whereas in other embodiments, FIG. 4 may illustrate an exemplary SoC. In at least one embodiment, devices illustrated in FIG. 4 may be interconnected with proprietary interconnects, standardized interconnects (e.g., PCIe) or some combination thereof. In at least one embodiment, one or more components of the computer and processor aspects 400 that are interconnected using compute express link (CXL) interconnects.

In at least one embodiment, the system in FIGS. 1-4 therefore include one or more execution units 408 in the IB or Ethernet hosts 202, 204, or the IB fabric/Ethernet/Interconnect devices 220 to support communication using an unreliable transport protocol. For example, at least one execution unit 408 of one host machine or of one IB fabric/Ethernet/Interconnect device supports communication to other processing units of the other host machines or of other IB fabric/Ethernet/Interconnect devices using UTP. The at least one execution unit 408 is further to request, as part of the communication, acknowledgement for receipt of a set of sequential messages communicated over multiple timepoints in the communication. The at least one execution unit 408 is further to receive the acknowledgement as a summary in a dense format.

In at least one embodiment, at least other processing unit can also support communication to the execution unit 408 and to other processing units using UTP. The at least one other processing unit is further to receive, as part of the communication, a request for acknowledgement of receipt of a set of sequential messages communicated over multiple timepoints in the communication by sending the one other processing unit a request for a summary. The one other processing unit is further to provide the summary, in acknowledgement, in a dense format. Further, the dense format is represented by fewer number of bits than the set of sequential messages and can include a bit mask representing the set of sequential messages received by one other processing unit of the plurality of processing units or can include a list of received sequence numbers that is associated with the set of sequential messages.

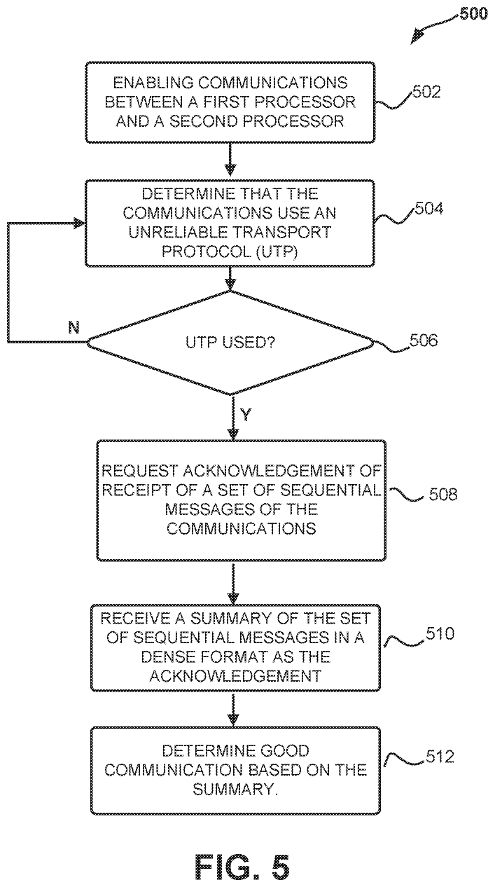

FIG. 5 illustrates a process flow or method 500 in a system of FIGS. 1-4 for explicit acknowledgement in unreliable transport protocols, according to at least one embodiment. The method 500, using explicit acknowledgement enables efficient network communication in an unreliable transport protocol. The method 500 includes enabling 502 communication between a first processor and a second processor, where the communication includes a set of sequential messages sent over multiple timepoints. The method 500 includes determining 504 that the communication uses UTP.

On the determination in the affirmative in at least a verification step 506, the method 500 includes requesting 508 acknowledgement, by the first processor, to the second processor of a receipt of the set of sequential messages. The method 500 includes receiving 510, in the first processor and from the second processor, a summary of the set of sequential messages in a dense format as the acknowledgement. The first processor can perform a comparison or other verification to confirm that the summary corresponds to the set of sequential messages sent. The first processor determine 512, as part of the method 500, that good communication is achieved for the set of sequential messages sent.

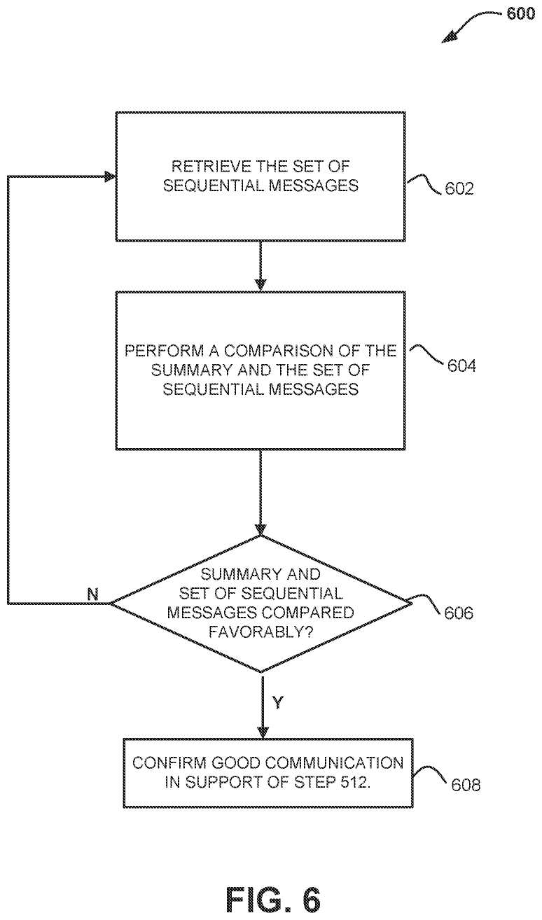

FIG. 6 illustrates yet another process flow or method 600 in a system for explicit acknowledgement in unreliable transport protocols, according to at least one embodiment. The method 600 may be in support of the method 500 of FIG. 5. For example, the method 600 includes retrieving 602 the set of sequential messages and performing 604 a comparison of the summary from step 510 in the method 500 and the set of sequential messages. In at least one embodiment, the reference to performing a comparison, as used herein, may be a direct comparison or may be in reference to ensuring that a number of or a sequence of bits as sent is confirmed as received by an indication in the summary, including by a bit mask, a listing of sequence numbers, or other counts that is complete (such as, ensuring that the summary does not indicate dropped packets). The method 600 confirms 608 the good communication determined in step 512 of the method 500 of FIG. 5, upon verification 606 of the summary being compared favorably to the set of sequential messages sent.

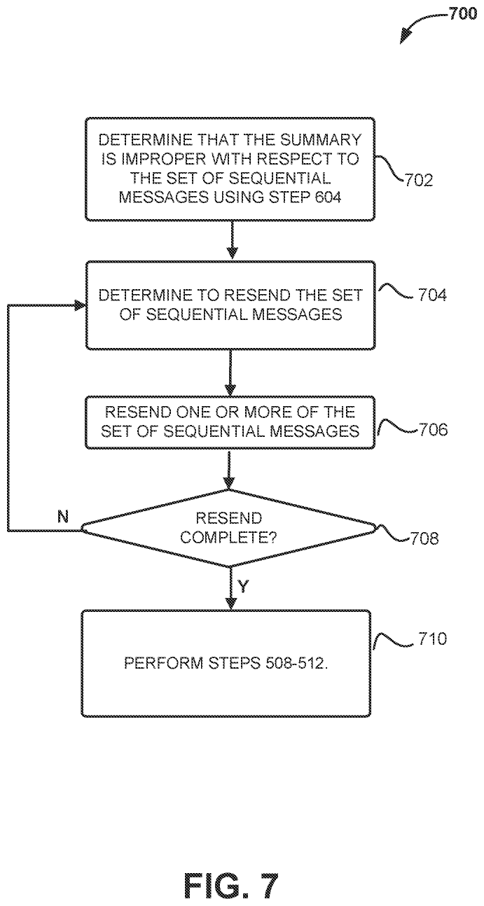

FIG. 7 illustrates a further process flow or method 700 in a system for explicit acknowledgement in unreliable transport protocols, according to at least one embodiment. The method 700 may be in support of the method 500 of FIG. 5 and of the method 600 in FIG. 6. For example, the method 700 includes determining 702 that the summary is improper with respect to the set of sequential messages because of an indication of missing packets, dropped packets, or on other basis where the summary is not compared favorably to the set of sequential messages. The method 700 includes determining 704 to resend one or more messages of the set of sequential messages. The method includes resending 706 at least part of the set of sequential messages, such as the one or more messages determined in step 704. Therefore, steps 704 and 706 may be performed upon a determination of a dropped packet in the summary from step 512. Further, the method 700 may be performed after step 606 provides determination of no favorable comparison between the summary and the set of sequential messages. Once the resending aspect of step 706 is complete, as verified in step 708, steps 508-512 may be repeated 710 by requesting acknowledgement for the resent package or for the entire set of sequential messages including the resent package.

In at least one embodiment, therefore, the systems and methods described in FIGS. 1-7 herein can address any communication protocol that is not based on TCP at least because of its lack of acknowledgement. The explicit acknowledgement in the dense format summary helps build reliability on single packet messages and improves a capability for large sets of sequential messages to be communicated. As the dense format summary is provided at the end of the sequence, a sender computer and a receiver computer may not be bothered with acknowledgement requirements for every single packet or massage.

For example, in central management protocols, including IB, lossy UD transport is used in the large scale of network to allow a center manager (CM), such as a subnet manager, to control multiple receivers in parallel. The CM send requests in iterations, each of which can cover all the relevant receivers in a round robin manner. This takes a longer time than a single receiver's processing time and the CM may use responses to each of the requests it sends if it were to be made a reliable messaging service. The CM therefore limits the number of requests it sends into the network in order to avoid possible drops of response packets due to a congestion time consumed in the network for each response packet, in the direction of the CM, for instance. This results from multiple responses occurring at the same time and may cause the CM to wait for responses to arrive after sending the limited number of requests and before sending additional requests into the network. As the processing time of each request, by a receiver computer, is longer than the time it takes to send the limited number of requests, a total execution time is substantial for such a messaging sequence.

In at least one embodiment, the systems and methods described in FIGS. 1-7 makes the request for acknowledgement an explicit packet or message and the receives a summary packet in response that includes a full list of received (and missed) sequence numbers or bits per packet. This allows UTP communication to occur in networks with reduced the total communication time. For example, in central management protocols, including IB, that relies on lossy unreliable datagram (UD) transport in large scale of network, it is now possible to allow a center manager (CM), such as a subnet manager, to control multiple receivers in parallel. The CM can send large sets of sequential messages, which may be independent and which may be agnostic to their order of receipt and processing on a receiver computer. For example, the order can be altered without harming the integrity of the operation because the summary still indicates the packets received or dropped irrespective of the order.

The result is that, instead of responses to each request and after each sent packet, the CM, in an explicit acknowledgement approach, only uses a single summary response from each of the receivers at the end of the messaging sequence. The limitations described with respect to congestion time and processing time are no longer relevant. Instead, the CM can send all the requests into the network without delays, reducing the total execution time of the messaging sequence. The use of the explicit acknowledgement packet and the summary response packet that includes a full list of received (and missed) sequence numbers or bit per packet enables such benefits.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors.

In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

In at least one embodiment, an arithmetic logic unit is a set of combinational logic circuitry that takes one or more inputs to produce a result. In at least one embodiment, an arithmetic logic unit is used by a processor to implement mathematical operation such as addition, subtraction, or multiplication. In at least one embodiment, an arithmetic logic unit is used to implement logical operations such as logical AND/OR or XOR. In at least one embodiment, an arithmetic logic unit is stateless, and made from physical switching components such as semiconductor transistors arranged to form logical gates. In at least one embodiment, an arithmetic logic unit may operate internally as a stateful logic circuit with an associated clock. In at least one embodiment, an arithmetic logic unit may be constructed as an asynchronous logic circuit with an internal state not maintained in an associated register set. In at least one embodiment, an arithmetic logic unit is used by a processor to combine operands stored in one or more registers of the processor and produce an output that can be stored by the processor in another register or a memory location.

In at least one embodiment, as a result of processing an instruction retrieved by the processor, the processor presents one or more inputs or operands to an arithmetic logic unit, causing the arithmetic logic unit to produce a result based at least in part on an instruction code provided to inputs of the arithmetic logic unit. In at least one embodiment, the instruction codes provided by the processor to the ALU are based at least in part on the instruction executed by the processor. In at least one embodiment combinational logic in the ALU processes the inputs and produces an output which is placed on a bus within the processor. In at least one embodiment, the processor selects a destination register, memory location, output device, or output storage location on the output bus so that clocking the processor causes the results produced by the ALU to be sent to the desired location.

Accordingly, in at least one embodiment, computer systems are configured to implement one or more services that singly or collectively perform operations of processes described herein and such computer systems are configured with applicable hardware and/or software that allow performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. In at least one embodiment, process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. References may also be made to providing, outputting, transmitting, sending, or presenting analog or digital data. In at least one embodiment, processes of providing, outputting, transmitting, sending, or presenting analog or digital data can be accomplished by transferring data as an input or output parameter of a function call, a parameter of an application programming interface or interprocess communication mechanism.

Although descriptions herein set forth example implementations of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A system for efficient network communication in an unreliable transport protocol, comprising:
a first processor to provide a plurality of communications to a second processor using the unreliable transport protocol, the plurality of communications associated with a set of sequential messages sent over multiple timepoints, wherein at least one communication of the plurality of communications comprises a request for acknowledgement from the second processor of a receipt of the set of sequential messages, and wherein the first processor is to receive a summary of the set of sequential messages in a dense format as the acknowledgement.

2. The system of claim 1, wherein the dense format is represented by fewer number of bits than the set of sequential messages.

3. The system of claim 1, wherein the dense format comprises a bit mask representing the set of sequential messages received by the second processor.

4. The system of claim 1, wherein the first processor is further to:
perform a comparison of the summary to the set of sequential messages; and
resend at least part of the set of sequential messages upon a determination of a dropped packet in the summary.

5. The system of claim 1, wherein the dense format comprises a list of received sequence numbers associated with the set of sequential messages.

6. The system of claim 1, wherein the request for acknowledgement is provide from the first processor before the set of sequential messages and wherein the request for acknowledgement is associated with one or more of a timing or a count for the set of sequential messages.

7. A system comprising:
at least one processing unit to support communication to a plurality of processing units using an unreliable transport protocol, wherein the at least one processing unit is further to request, as part of the communication, acknowledgement for receipt of a set of sequential messages communicated over multiple timepoints in the communication, and wherein the at least one processing unit is further to receive the acknowledgement as a summary in a dense format.

8. The system of claim 7, wherein the dense format is represented by fewer number of bits than the set of sequential messages.

9. The system of claim 7, wherein the dense format comprises a bit mask representing the set of sequential messages received by another one of the plurality of processing units.

10. The system of claim 7, wherein the dense format comprises a list of received sequence numbers associated with the set of sequential messages.

11. The system of claim 7, wherein the request for acknowledgement is provide from the first processor before the set of sequential messages and wherein the request for acknowledgement is associated with one or more of a timing or a count for the set of sequential messages.

12. A system comprising:
at least one processing unit to support communication to a plurality of processing units using an unreliable transport protocol, wherein the at least one processing unit is further to receive, as part of the communication, a request for acknowledgement of receipt of a set of sequential messages communicated over multiple timepoints in the communication, and wherein the at least one processing unit is further to provide the acknowledgement as a summary in a dense format.

13. The system of claim 12, wherein the dense format is represented by fewer number of bits than the set of sequential messages.

14. The system of claim 12, wherein the dense format comprises a bit mask representing the set of sequential messages received in the at least one processing unit.

15. The system of claim 12, wherein the dense format comprises a list of received sequence numbers associated with the set of sequential messages.

16. The system of claim 12, wherein the request for acknowledgement is provide from the first processor before the set of sequential messages and wherein the request for acknowledgement is associated with one or more of a timing or a count for the set of sequential messages.

17. A method for efficient network communication in an unreliable transport protocol, comprising:
enabling communication between a first processor and a second processor using the unreliable transport protocol, the communication comprising a set of sequential messages sent over multiple timepoints;
requesting acknowledgement, by the first processor, to the second processor of a receipt of the set of sequential messages; and
receiving, in the first processor and from the second processor, a summary of the set of sequential messages in a dense format as the acknowledgement.

18. The method of claim 17, further comprising:
performing a comparison of the summary to the set of sequential messages; and
resending, by the first processor and to the second processor, at least part of the set of sequential messages upon a determination of a dropped packet in the summary.

19. A method for efficient network communication in an unreliable transport protocol, comprising:
enabling communication between a first processor and a second processor using the unreliable transport protocol, the communication comprising a set of sequential messages sent over multiple timepoints;
receiving, in the second processor and from the first processor, a request for acknowledgement of a receipt of the set of sequential messages; and
providing, from the second processor and to the second processor, a summary of the set of sequential messages in a dense format as the acknowledgement.

20. The method of claim 19, further comprising:
receiving, in the second processor and from the first processor, at least part of the set of sequential messages upon a determination of a dropped packet in the summary that is based in part on a comparison of the summary to the set of sequential messages.
